(19) United States
(12) Patent Application Publication
(10) Pub. No.: US 2017/0238641 A1
(43) Pub. Date: Aug. 24, 2017

(54) HEADGEAR HAVING A PACIFIER TETHER

(71) Applicant: Fruwah Boma CHAPMAN, Alexandria, VA (US)

(72) Inventor: Fruwah Boma CHAPMAN, Alexandria, VA (US)

(21) Appl. No.: 15/048,320

(22) Filed: Feb. 19, 2016

(51) Int. Cl. A42B 1/24; A61J 17/00; A42B 1/06

(52) U.S. Cl. CPC A42B 1/24; A42B 1/062; A61J 17/001

(57) ABSTRACT

An infant's headgear having a tether is provided for retaining a pacifier. The present invention prevents the pacifier from dropping to the ground and becoming dirty or lost when it falls out of the infant's mouth. The headgear is attached to a keeper which anchors a fastening member that releasably connects to a first end of the tether. An opposite second end of the tether is adapted to releasably connect to the pacifier. The positioning of the tether makes it easy for an infant to find a pacifier hanging from the headgear so that the infant can readily reach out and grasp the it on their own and place it back in his or her mouth without relying on the help of a caregiver.

### FIELD OF THE INVENTION

The present invention relates generally to an infant accessory device, and more particularly, to a tether for releasably retaining a pacifier to a hat, beanie, visor or other type of headgear worn by infants.

### BACKGROUND

Pacifiers are commonly used to sooth and quiet infants, as well as other young children such as toddlers, when they become tired or agitated. For instance, sucking on a pacifier provides an infant with a soothing comfort that puts them at ease. Typical pacifiers comprise a nipple portion, a holder or grip portion, and a face plate or shield portion. When a pacifier falls out of an infant's mouth, the infant often becomes upset and cries. To make matters worse, many infants lack the awareness or motor skills necessary to locate the fallen pacifier and reinsert it in their mouth, even though it may be in relatively close proximity to them.

Caregivers also often have difficulty locating or retrieving a dropped pacifier that has fallen out of an infant's mouth. Thus, there is a risk that the dropped pacifier can be lost or otherwise irretrievable. Moreover, even when the dropped pacifier is successfully located, it is usually too unsanitary to put back in the infant's mouth without first cleaning it. It is a common problem for caregivers of infants to have to pick up and clean a dirty pacifier when an infant drops it on the ground and in public places. Both infants and caregivers can easily become irritated when this cycle of dropping and cleaning the pacifier needs to be frequently repeated.

Accordingly, pacifier securing devices are sometimes used to secure the pacifier to an infant's shirts so that the pacifier is kept in dose proximity to the infant and is protected from falling on unsanitary objects and surfaces. Conventional pacifier securing devices include a leash which attaches a pacifier to an infant's shirt or an object, such as a stroller, toy or bed. These conventional leash devices, however, can be very unsafe since they provide for the opportunity that the leash may become dangerously tangled around the infant's neck, thus strangling the infant.

Additionally, conventional securing devices which attach a pacifier to an infant's shirt disadvantageously fail to provide any indication to the infant as to where the pacifier is when it falls out the infant's mouth. Since infants lack developed motor skills, they may fail to see a dropped pacifier that is dangling from their shirt below their line of sight. Therefore, there exists a substantial need for a device which allows an infant's pacifier to be kept constantly at the ready in the general vicinity of the infant's mouth, and which makes it easy for the infant to find and grasp the pacifier in order to enhance and promote the development of fine motor skills.

### SUMMARY

The present invention provides a pacifier strap which enables a parent or other caregiver to removably attach a pacifier to an infant's headgear, such as a hat, beanie, or visor, among others. The strap retains the pacifier within the infant's reach and protects it from falling on unsanitary surfaces. Since infants lack developed motor skills, they may not be able to find or even see a dropped pacifier when it falls below their visible line of sight. The headgear of the present invention advantageously allows a pacifier to dangle in front of an infant's line of sight so that the infant can easily see the object and retrieve it on their own and insert it into their own mouth without additional assistance from a caregiver.

Accordingly, the present invention advantageously promotes independence to the infant as he or she may grasp the pacifier from the dangling strap and insert into their mouth when desired. Thus, the present invention assists an infant in locating the pacifier, reaching for it, grasping it and putting it in their mouth, which correspondingly helps improve the infant's tine motor skills. The configuration of the headgear and tether also limits the risk of asphyxiation since the infant can spit out the pacifier at will. Parent or guardian supervision is always advised.

### BRIEF DESCRIPTION OF THE DRAWINGS

Various advantages, features and functions of the present invention will become readily apparent and better understood in view of the following description and accompanying drawings. The following description is not intended to limit the scope of the present invention, but instead merely provides exemplary embodiments for ease of understanding.

FIG. 1 is a perspective view of an embodiment of the present invention in which a fastening member is engaged to a keeper.

FIG. 2 is a perspective view of the embodiment shown in FIG. 1 in which the fastening member is disengaged from the keeper.

FIG. 3 is a perspective view of a variation of the present invention shown in FIG. 1.

FIG. 4 is a perspective view of another variation of the present invention.

It should be noted that the drawing figures are not necessarily drawn to scale, but instead are drawn to provide a better understanding of the components thereof, and are not intended to be limiting in scope, but rather to provide exemplary illustrations. It should further be noted that the figures illustrate exemplary configurations of the present invention, and in no way limit the structures or configurations thereof according to the present disclosure.

### DETAILED DESCRIPTION

The present invention is directed to headgear having a pacifier tether for infants. An infant pacifier 2 typically includes at least a nipple 4 for the infant to suckle on, and a holder 6, such as a ring-shaped gripping member, for the infant or caregiver to grasp without touching and contaminating the nipple when picking up the pacifier.

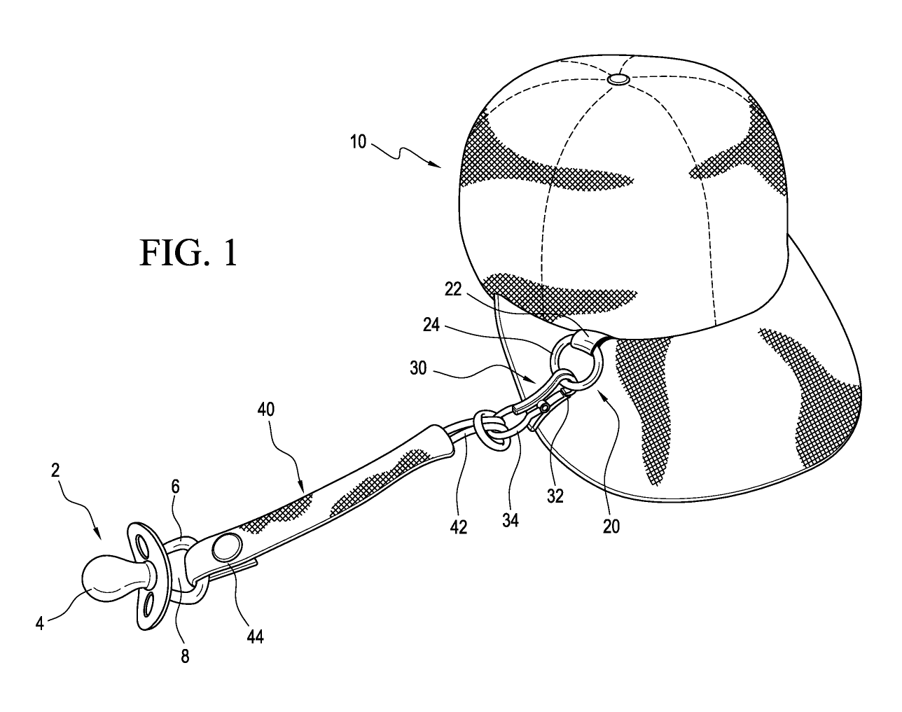

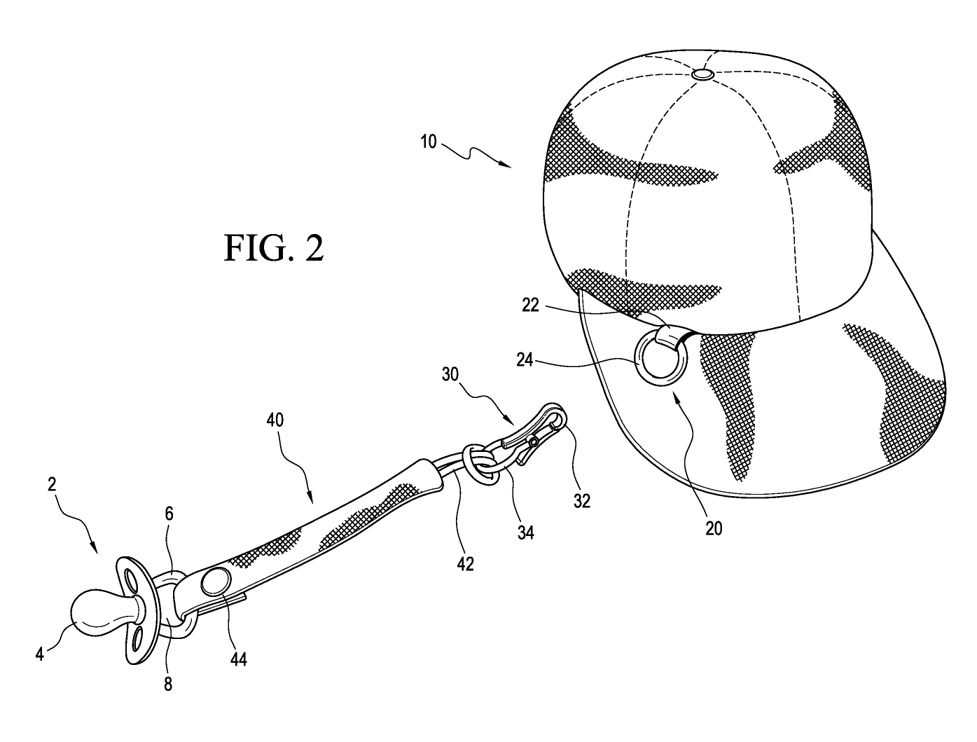

Types of infant headgear may include hats, beanies, visors, convertible visors, caps, bucket hats, berets, bobble hats, Gatsby hats, eight point hats, Windsor caps, aviator hats, cloche hats, cowboy hats and head ties, among others. Referring to FIGS. 1 and 2, an exemplary baseball hat 10 includes a keeper 20 having an attachment member 22 and an engaging member 24, wherein the attachment member 22 is coupled to the engaging member 24. The attachment member 22 may be fixedly, or permanently, attached to a front region of the hat. For example the attachment member 22 may be a fabric loop integrally sewn into a seam of the hat between a front panel and a brim thereof on either side. The engaging member 24 may be a key ring, an O-ring, a D-ring, a square ring or other geometrically shaped eyelet.

A corresponding fastening member 30 is configured to releasably engage the engaging member 24. The fastening member 30 may be a clamping device having a grip end 32 for releasably engaging the corresponding engaging member 24, and an opposite ring end 34 for releasably securing to a tether member 40. It should be appreciated that the fastening member 30 may be a clamping device such as a spring clamp, a carbineer or a snap hook, among others. In this arrangement, the engaging member 24 serves as an anchor for attaching with the grip end 32 of the fastening member 30.

The tether member 40 may be an elongated flexible strap having a first attachment end 42 and an opposite second attachment end 44. The first attachment end 42 is adapted for removably attaching to the ring end 34 of the fastening member 30. Further, the second attachment end 44 is adapted for removably attaching to an accessory device, such as the pacifier 2, and more specifically, to the holder 6 of the pacifier.

As shown in FIGS. 1 and 2, the first attachment end 42 includes a retention loop, such as a paracord or rope, which removably secures the tether 40 to the fastening member 30 by doubling an end of the retention loop upon itself and passing it through the interior of the ring end 34 of the fastening member 30. The second attachment end 44 includes a snap button comprising a male snap portion and a corresponding female snap portion adapted to receive the male snap portion. As illustrated, the end of the tether 40 is provided with the male snap portion and is threaded through the orifice 8 of the holder 6 so as to engage with the corresponding female snap portion for removably securing the pacifier to the tether. It should be appreciated that the relative placement of the male and female snap portions on the second attachment end of the tether 40 may be interchanged.

It should also be appreciated that the placement of the retention loop of the first attachment end 42 and the snap button of the second attachment end 44 may be swapped, such that the first attachment end comprises the snap button and the second attachment end comprises the retention loop. Further, both the first and second attachment ends may comprise respective retention loops, or alternatively, both the first and second attachment ends may comprise respective snap buttons. Moreover, the first and/or second attachment ends of the tether 40 may include other removable attachment means, such as hook and loop fasteners, slide buckles, buttons and clips.

For instance, the first and second attachment ends 42, 44 may comprise hook and loop fasteners, such as Velcro™, for attaching to the fastening member 30 and the pacifier 2, respectively. The hook and loop fastener means comprises a plurality of hooks releasably engageable with a corresponding plurality of loops, and are respectively arranged on the tether in a manner similar to the aforementioned male and female snap portions of the snap button. Also akin to the male and female snap portions of the snap button, the positioning of the hooks and loops on the tether 40 can be reversed.

In the arrangement where the second attachment end 44 comprises the retention loop, the retention loop is adapted to couple the pacifier to the tether. For instance, the retention loop is first passed through an orifice 8 of the pacifier holder 6, and then the remainder of the tether is passed through the retention loop, thus doubling an end of the loop upon itself to form a double retention knot for securely retaining the pacifier.

The tether 40 is configured to hang from the hat 10 in a position located in front of the infant's line of sight so that the infant can easily locate and grab the pacifier 2 as desired, thus providing soothing comfort to the infant as well as enhance and promote infant's fine motor skill development. The placement of the keeper 20 is located between the front or anywhere within the 360 degree radius of the hat and the brim of the hat so to advantageously allow the tether 40 and pacifier 2 to dangle within the infant's visible range without obstructing or blocking the infant's direct view or peripheral view. In the event that the pacifier falls out of the infant's mouth during use, the tether 40 acts to prevent the pacifier from touching the ground or other unsanitary surface, as well retain the pacifier in the aforementioned position within the infant's view while eliminating any choking or strangling hazard. Furthermore, the fastening member 30, the tether 40 and the pacifier 2 may be used independently from the hat 10 in the event that a user wants to transfer them to another object, such as a garment bag, diaper bag, handbag, etc.

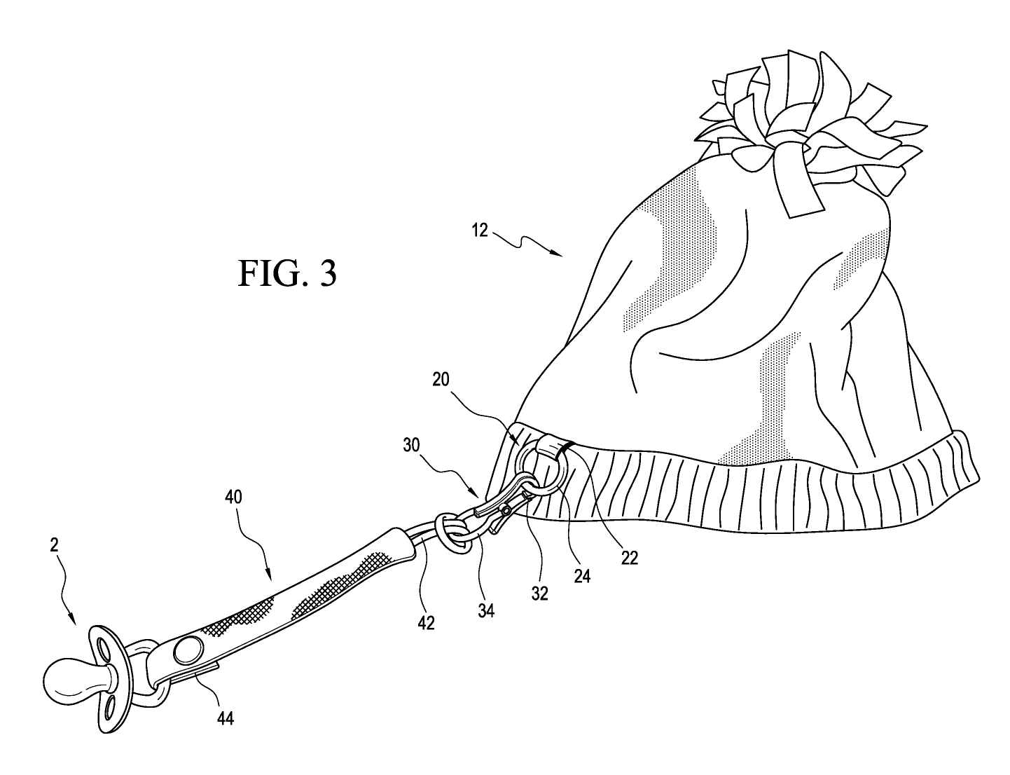

FIG. 3 shows a variation of the headgear is a beanie hat 12. The keeper 20, the fastening member 30 and the tether member 40 are arranged in a manner similar to that shown in FIGS. 1 and 2. The attachment member 22 is directly fixed to a front 360 degree circumference region of the beanie so that the tether 40 and pacifier 2 dangle therefrom within the infant's visible line of sight without blocking the infant's view.

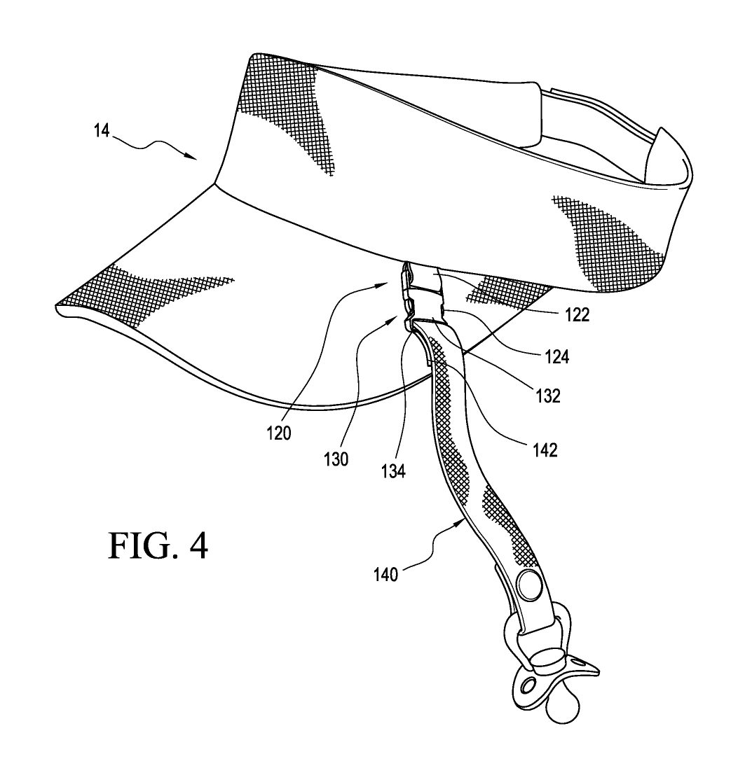

FIG. 4 shows another variation of the headgear is a visor 14, which includes a keeper 120 having an attachment member 122 coupled to an engaging member 124, such as a male slide release buckle. A fastening member 130 includes a grip end 132, such as a female slide release buckle, configured to detachably connect with the engaging member 124. An opposite ring end 134 of the fastening member is configured to releasably connect to a first attachment end 142 of a tether member 140. For instance, the ring end 134 may have an opening or an eyelet for threading the first attachment end 142 therethrough.

Various other modifications and changes will be apparent to those of ordinary skill in the art without departing from the spirit and scope of the present invention. Applicant intends that these variations and modifications are included as part of the present invention and are not intended to limit the scope of the invention. Applicant does not intend the present application to be limited to only those embodiments outlined above or shown in the figures since features shown in particular embodiments may be incorporated into other embodiments. The present application is intended to cover such alternatives, modifications, and equivalents as may be included within the spirit and scope of the invention as defined by the appended claims.

What is claimed is:

1. A pacifier retaining apparatus, comprising:
a headgear for an infant's head;
a keeper attached to the headgear, the keeper having an attachment member and an engaging member coupled to each other, wherein the attachment member is fixedly attached to the headgear;
a fastening member configured to detachably engage with the keeper; and
a tether member having a first attachment end adapted to releasably connect to the fastening member and a second attachment end adapted to releasably connect to a pacifier,
wherein the tether member is configured to dangle the pacifier from the headgear at a position located within the infant's line of sight and within the infant's reach when the pacifier falls out of the infant's mouth.

2. The pacifier retaining apparatus according to claim 1, wherein the fastening member includes a grip end for releasably engaging the engaging member of the keeper, and an opposite ring end for releasably connecting to the first attachment end of the tether.

3. The pacifier retaining apparatus according to claim 2, wherein the fastening member is a clamping device.

4. The pacifier retaining apparatus according to claim 3, wherein the clamping device is a spring clamp.

5. The pacifier retaining apparatus according to claim 2, wherein the first attachment end includes a retention loop adapted to removably secure to the ring end of the fastening member.

6. The pacifier retaining apparatus according to claim 5, wherein the retention loop is a paracord or rope.

7. The pacifier retaining apparatus according to claim 1, wherein the engaging member is an O-ring.

8. The pacifier retaining apparatus according to claim 1, wherein the attachment member is a fabric loop integrally formed on a front portion of the headgear.

9. The pacifier retaining apparatus according to claim 1, wherein the tether member is an elongated flexible strap.

10. The pacifier retaining apparatus according to claim 1, wherein the second attachment end includes a snap button.

11. The pacifier retaining apparatus according to claim 1, wherein the headgear is a baseball hat.

12. The pacifier retaining apparatus according to claim 1, wherein the headgear is a beanie.

13. The pacifier retaining apparatus according to claim 1, wherein the headgear is a visor.

14. A kit comprising the pacifier retaining apparatus according to claim 1, and including at least one pacifier for connecting to the tether member.

15. The kit according to claim 14, wherein the pacifier includes a holder having an orifice configured to releasably connect to the second attachment end of the tether member.

16. An accessory device retaining apparatus, comprising:
a headgear for an infant's head;
a keeper fixedly attached to the headgear and having an attachment member and an engaging member;
a fastening member configured to detachably engage the keeper; and
a tether member configured to removably secure the accessory device from the headgear.

17. An accessory device retaining apparatus according to claim 16, wherein the engaging member is a male slide release buckle and the fastening member is a female slide release buckle.

18. The pacifier retaining apparatus according to claim 17, wherein the female slide release buckle includes a ring end for releasably connecting to a first attachment end of the tether member.

19. An accessory device retaining apparatus according to claim 18, wherein the tether member includes a second attachment end adapted to releasably secure the accessory device.

20. An accessory device retaining apparatus according to claim 19, wherein the accessory device is a pacifier.
